(19) United States
(12) Patent Application Publication
(10) Pub. No.: US 2012/0185616 A1
(43) Pub. Date: Jul. 19, 2012

(54) USB Version Recognition Device

(75) Inventors: Yung-Hsien Ho, Taipei City (TW); Pei-Yen Chien, Taipei City (TW)

(73) Assignee: ELITEGROUP COMPUTER SYSTEMS CO., LTD., Taipei City (TW)

(21) Appl. No.: 13/088,786

(22) Filed: Apr. 18, 2011

(30) Foreign Application Priority Data
Jan. 19, 2011 (TW) 100201250

(51) Int. Cl. G06F 13/10

(52) U.S. Cl. 710/11

(57) ABSTRACT

A USB version recognition device includes an indication module, a USB connector, an information source module, and a control module. The USB connector is for connecting with a USB device and receiving a first version message of the USB device. The information source module stores a second version message therein and is connected to the USB connector. The controller module is connected to the indication module and the information source module, and is able to compare the first version message with the second version message to generate an operating version message and show the latter via the indication module.

### FIELD OF THE INVENTION

The present invention relates to a USB version recognition device, and more particularly to a USB version recognition device capable of comparing the USB version supported by an electronic device with the USB version supported by a USB device connected to the electronic device and generating an operating USB version.

### BACKGROUND OF THE INVENTION

Conventionally, the connection interfaces between a computer and different peripherals include RS232 and PS2. While the currently available computer hosts have largely increased processing speed, the peripherals connected thereto usually have lower operating performance than that of the computer hosts to thereby adversely affect the overall processing speed. It is therefore tried by persons in the research and development departments of related industrial fields to develop new transmission interfaces to satisfy the heavy demands for upgraded overall computer performance.

Therefore, new generation computer transmission interfaces have been introduced into the market. Among the cabled transmission interfaces, there are included Universal Serial Bus (USB), IEEE 1394, etc. The earliest USB 1.0 interface supports a transmission rate of 1.5 Mbps, the improved USB 1.1 interface supports a higher transmission rate of 12 Mbps, and the further improved USB 2.0 interface supports a largely increased transmission rate of 480 Mbps, which is forty times as fast as the previous USB version 1.1. Now, the newest USB 3.0 interface has launched into the market, making USB interfaces the main trend in the new generation computer transmission interfaces.

However, the USB interfaces with different new and old versions provide different transmission speeds, and it is not easy for a general user to determine the exact USB version of a USB device being currently used by the user.

### SUMMARY OF THE INVENTION

A primary object of the present invention is to provide a USB version recognition device, which enables a user using USB device to know the current transmission rate and the USB version supporting that transmission rate.

To achieve the above object, the USB version recognition device according to the present invention includes an indication module, a USB connector, an information source module, and a control module. The USB connector is for connecting with a USB device and receiving a first version message of the USB device. The information source module stores a second version message therein and is connected to the USB connector. The controller module is connected to the indication module and the information source module, and is able to compare the first version message with the second version message to generate an operating version message and show the latter via the indication module.

In the present invention, the operating version message is one of the first and the second version message that has a lower transmission rate.

According to the present invention, the USB device can be a combination of an electronic device and at least one USB connection interface thereof.

According to the present invention, the control module can be any one of a Basic Input/Output System (BIOS), a driver, and a type of firmware.

According to the present invention, the indication module can be any one of a liquid crystal display (LCD), a set of light-emitting-diode (LED) indicators, a speaker, and a buzzer.

According to the present invention, the USB version recognition device can be applied in a computer host or an electronic device.

According to the present invention, the first version message, the second version message and the operating version message respectively include a version number, a transmission rate, or a combination thereof.

In the present invention, the information source module is a chipset.

With the above arrangements, the USB version recognition device of the present invention has the following advantage:

When a user connects a USB device to an electronic device, the USB version recognition device of the present invention allows the user to know the exact USB version and transmission rate currently being used to transmit data between the USB device and the electronic device.

### BRIEF DESCRIPTION OF THE DRAWINGS

The structure and the technical means adopted by the present invention to achieve the above object can be best understood by referring to the following detailed description of the preferred embodiments and the accompanying drawings, wherein

FIG. 1 is a block diagram of a USB version recognition device according to the present invention;

FIG. 2 schematically shows the USB version recognition device of the present invention according to a first embodiment thereof;

FIG. 3 that is a flowchart showing the USB version recognition device of the present invention according to a first embodiment thereof.

FIG. 4 schematically shows the USB version recognition device of the present invention according to a second embodiment thereof;

FIG. 5 schematically shows the USB version recognition device of the present invention according to a third embodiment thereof;

FIG. 6 schematically shows the USB version recognition device of the present invention according to a fourth embodiment thereof;

FIG. 7a is a top view of an external expansion card, on which the USB version recognition device of the present invention according to a fifth embodiment thereof is arranged; and

FIG. 7b is a perspective view of FIG. 7a.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

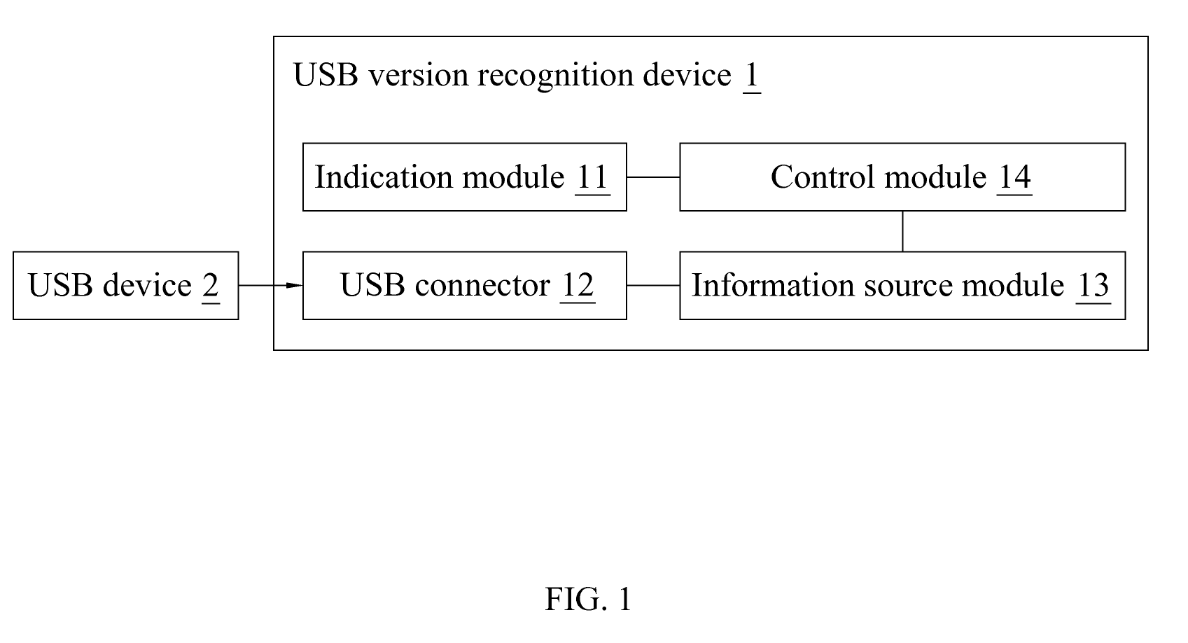

Please refer to FIG. 1 that is a block diagram of a USB version recognition device 1 according to the present invention. As shown, the USB version recognition device 1 includes an indication module 11, a USB connector 12, an information source module 13, and a control module 14. The USB connector 12 is provided for connecting with a USB device 2 and receiving a first version message from the USB device 2. The information source module 13 stores a second version message therein, and is connected to the USB connector 12. The control module 14 is connected to the indication module 11 and the information source module 13, and is able to compare the first version message with the second version message to generate an operating version message and displays the latter via the indication module 11. Wherein, the operating version message is one of the first and the second version message that has a lower transmission rate.

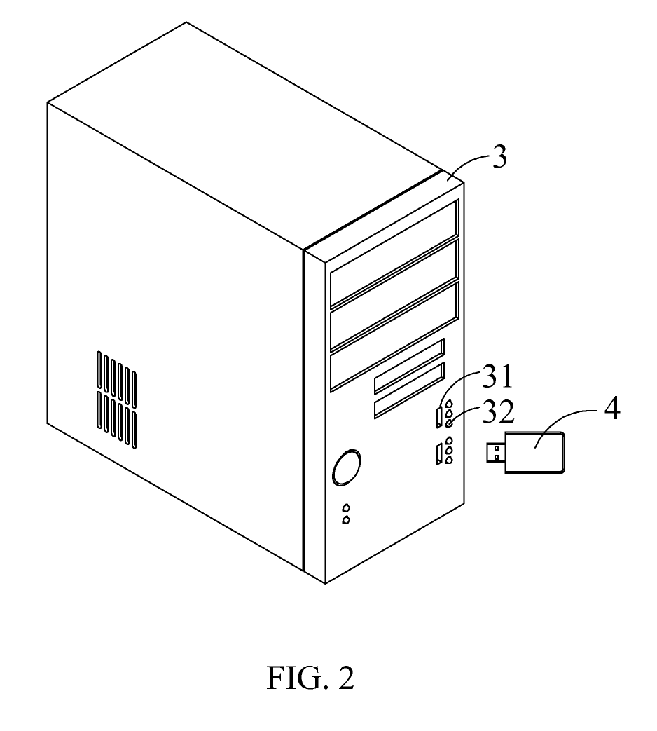

Please refer to FIG. 2 that schematically shows the USB version recognition device of the present invention according to a first embodiment thereof. In addition, the first embodiment can be deemed a best mode of the present invention. In the first embodiment, the USB version recognition device is arranged on a main board mounted in a computer host 3. In the computer host 3, there are installed a Basic Input/Output System (BIOS), which serves as the control module of the present invention; and a chipset serving as the information source module of the present invention. On a front face of the computer host 3, a plurality of light-emitting-diode (LED) indicators 32 is provided to serve as the indication module, and two USB connectors 31 are provided for a USB device 4 to connect thereto. It is noted the control module can be otherwise a driver provided in an operating system of the computer, and the indication module can be otherwise a speaker or a buzzer to indicating different transmission rate by different sounds.

In the first embodiment, the USB device 4 supports USB version 2.0 while the computer-supported USB version stored in the chipset is USB 3.0. When the USB device 4 is connected to the USB connector 31, the BIOS installed in the computer host 3 starts comparing the USB version 3.0 stored in the chipset with the USB version 2.0 of the USB device 4. Although the chipset supports USB versions up to 3.0, the USB device 4 supports only USB version 2.0. Therefore, data can only be transmitted between the computer host 3 and the USB device 4 at the transmission rate supported by the USB version 2.0. That is, the current operating USB version and the available transmission rate thereof is USB version 2.0. The BIOS will show this information via one of the LED indicators 32 that is defined as 2.0, so as to remind a user that the current operating USB version and the available transmission rate thereof is USB 2.0.

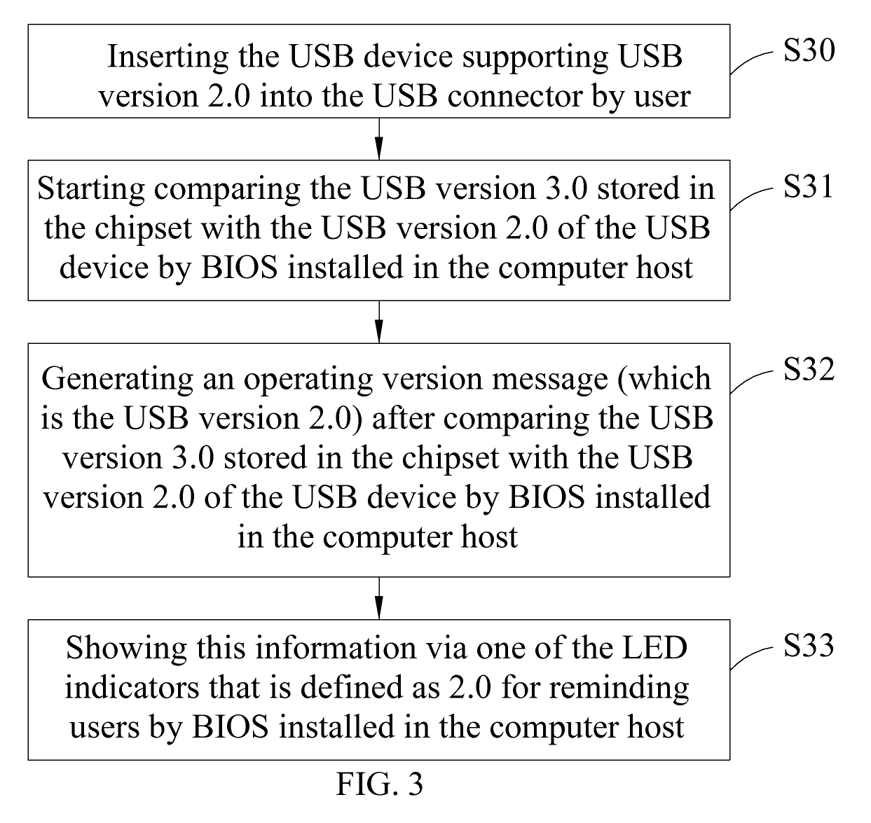

Please refer to FIG. 3 that is a flowchart showing the execution method of the best mode of the present invention, the execution method comprises the steps of: (S30) inserting the USB device supporting USB version 2.0 into the USB connector by users; (S31) comparing the USB version 3.0 stored in the chipset with the USB version 2.0 of the USB device by BIOS installed in the computer host; (S32) generating an operating version message (which is the USB version 2.0) after comparing the USB version 3.0 stored in the chipset with the USB version 2.0 of the USB device by BIOS installed in the computer host; and (S33) showing this information via one of the LED indicators that is defined as 2.0 for reminding users by BIOS installed in the computer host.

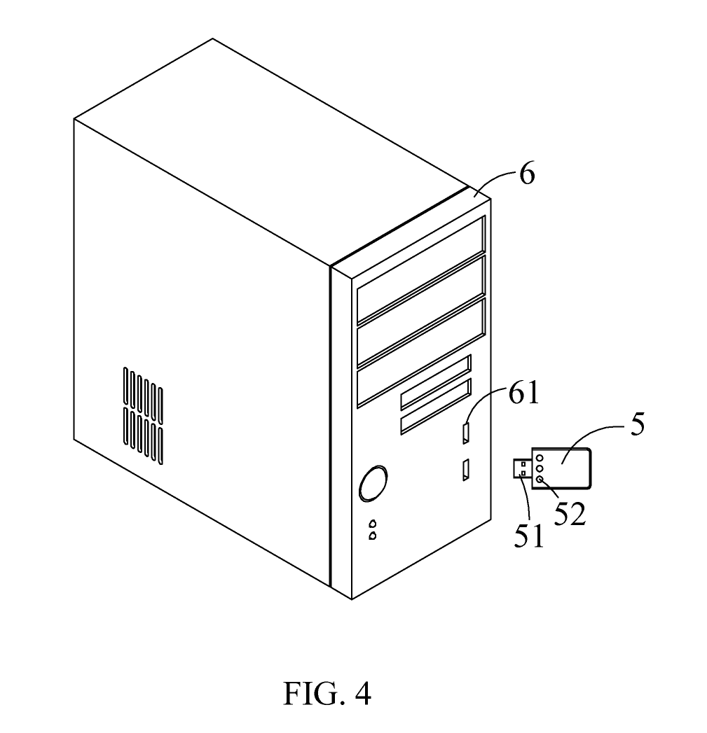

Please refer to FIG. 4 that schematically shows the USB version recognition device of the present invention according to a second embodiment thereof. In the second embodiment, the USB version recognition device is arranged on a USB flash drive 5. The USB drive 5 is internally provided with a type of firmware that serves as the control module of the present invention. The USB flash drive 5 also has a chipset provided therein to serve as the information source module of the present invention. The USB flash drive 5 further includes a USB connector 51 and three LED indicators 52 serving as the indication module of the present invention. In the illustrated second embodiment, a computer host 6 and USB connection interfaces 61 provided thereon is the USB device 2 shown in FIG. 1.

In the second embodiment, the computer host 6 supports USB version 1.0 and the chipset in the USB flash drive 5 stores the USB version 3.0 therein. When the USB flash drive 5 is connected to one of the USB connection interfaces 61 on the computer host 6, the firmware in the USB flash drive 5 starts comparing the USB version 1.0 supported by the computer host 6 with the USB version 3.0 stored in the USB flash drive 5. Although the USB flash drive 5 supports the transmission rate up to USB version 3.0, the computer host 6 supports only the transmission rate of USB version 1.0. Therefore, data can only be transmitted between the USB flash drive 5 and the computer host 6 at the transmission rate supported by the USB version 1.0. That is, the current operating USB version and the available transmission rate thereof between the computer host 6 and the USB flash drive 5 is USB version 1.0. The firmware will show this information via one of the three LED indicators 52 that is defined as 1.0, so as to remind a user that the current operating USB version and the available transmission rate thereof is USB 1.0.

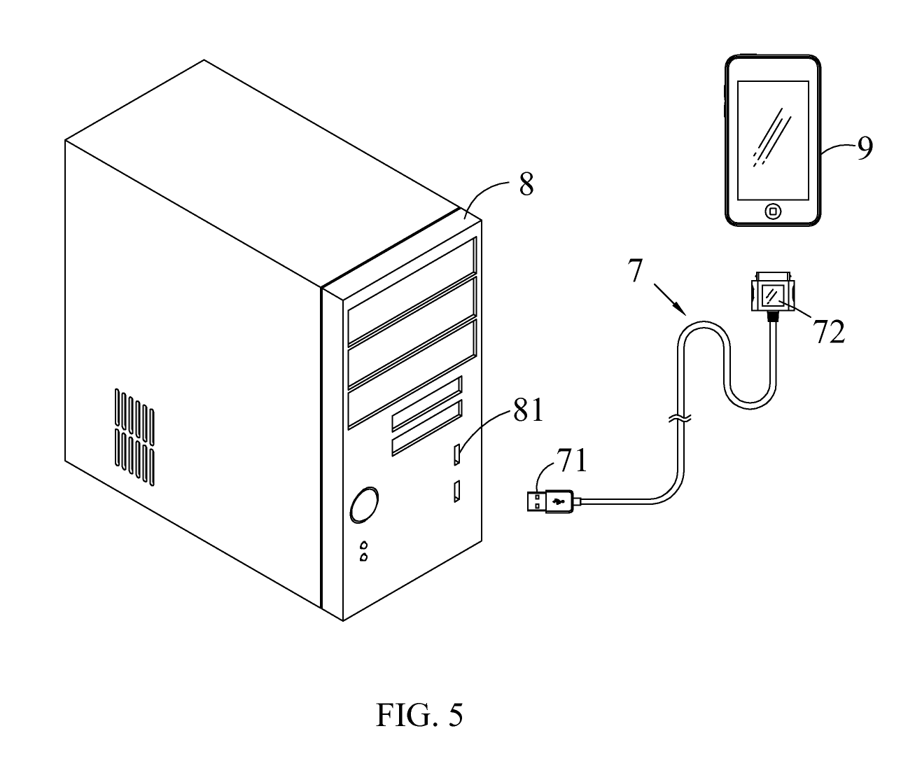

Please refer to FIG. 5 that schematically shows the USB version recognition device of the present invention according to a third embodiment thereof. In the third embodiment, the USB version recognition device is arranged in a connector at one of two ends of a USB transmission cable 7. The other end of the transmission cable 7 is a USB connector 71 for connecting to a computer host 8. A liquid crystal display (LCD) 72 is provided on the connector of the transmission cable 7 provided with the USB version recognition device to serve as the indication module of the present invention. The transmission cable 7 is internally provided with firmware that serves as the control module of the present invention. Similarly, the USB transmission cable 7 uses a chipset as the information source module of the present invention. The computer host 8 and USB connection interfaces 81 provided thereon is the USB device as mentioned in the description of the present invention.

In the third embodiment, the computer host 8 supports the USB version 2.0 and the chipset in the USB transmission cable 7 stores the USB version 1.0 therein. When the USB transmission cable 7 is connected at the end with the LCD 72 to a mobile phone 9 and at the USB connector 71 to one of the USB connection interfaces 81 on the computer host 8, the firmware in the USB transmission cable 7 starts comparing the USB version 2.0 supported by the computer host 8 with the USB version 1.0 stored in the chipset of the USB transmission cable 7. Although the computer host 8 supports the transmission rate up to USB version 2.0, the USB transmission cable 7 supports only the transmission rate of USB version 1.0. Therefore, data can only be transmitted between the computer host 8 and the mobile phone 9 at the transmission rate supported by USB version 1.0. That is, the current operating USB version and the available transmission rate thereof is USB version 1.0. The firmware will show this information in the LCD 72 so as to remind a user that the current operating USB version and the available transmission rate thereof is USB 1.0. Meanwhile, the available transmission rate is shown in the LCD 72.

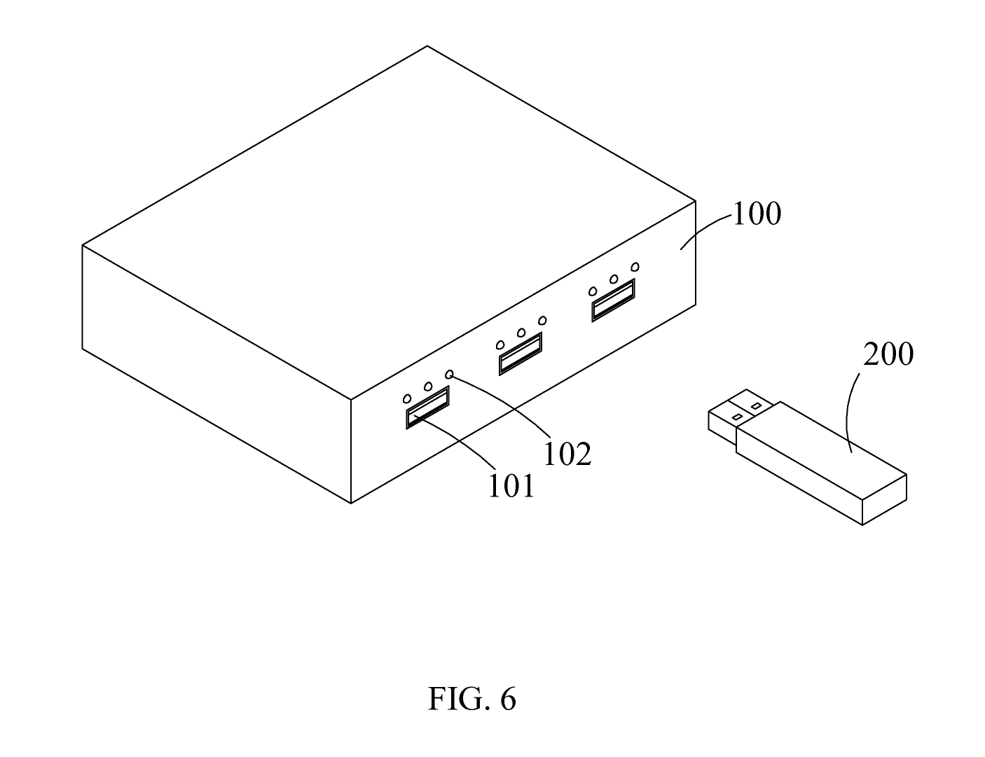

Please refer to FIG. 6 that schematically shows the USB version recognition device of the present invention according to a fourth embodiment thereof. In the fourth embodiment, the USB version recognition device is arranged in a USB hub 100. The USB hub 100 is internally provided with a driver to serve as the control module of the present invention, and a chipset to serve as the information source module of the present invention. Further, the USB hub 100 is provided with a plurality of USB connectors 101 for respectively connecting with a USB device 200. Three LED indicators 102 are provided corresponding to each of the USB connectors 101 to serve as the indication module of the present invention.

In the fourth embodiment, the USB device 200 supports the USB version 3.0 and the chipset in the USB hub 100 also stores the USB version 3.0 therein. When the USB device 200 is connected to one of the USB connectors 101 on the USB hub 100, the driver in the USB hub 100 starts comparing the USB version stored in the chipset with the USB version supported by the USB device 200. Since both of the USB hub 100 and the USB device 200 support the USB versions 3.0, the current operating USB version and the available transmission rate thereof is USB version 3.0. The driver will show this information via one of the three LED indicators 102 that is defined as 3.0 so as to remind a user that the current operating USB version and the available transmission rate thereof is USB 3.0.

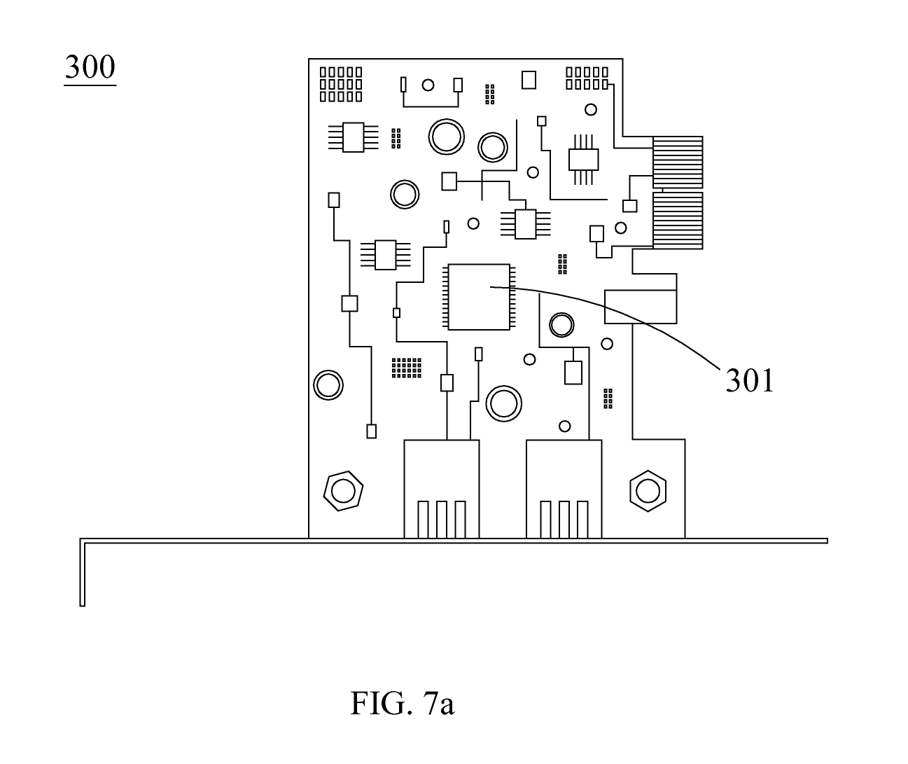

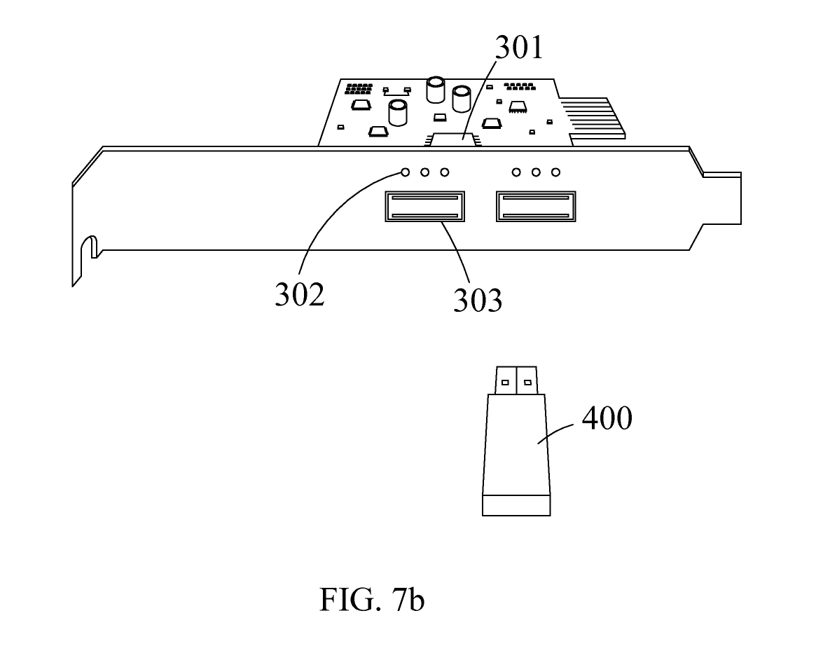

Please refer to FIGS. 7a and 7b that are top and perspective views, respectively, of an external expansion card 300, on which the USB version recognition device of the present invention according to a fifth embodiment thereof is arranged. In the fifth embodiment, the external expansion card 300 having the USB version recognition device of the present invention arranged thereon is internally provided with a type of firmware to serve as the control module of the present invention and a chipset 301 to serve as the information source module of the present invention. The external expansion card 300 is also externally provided with a plurality of USB connectors 303 for respectively connecting with a USB device 400, and with a plurality of LED indicators 302 corresponding to each of the USB connectors 303 to service as the indication module of the present invention.

In the fifth embodiment, the USB device 400 supports the USB version 2.0 and the chipset 301 in the external expansion card 300 stores the USB version 1.0 therein. When the USB device 400 is connected to one of the USB connectors 303 on the external expansion card 300, the firmware in the external expansion card 300 starts comparing the USB version 1.0 stored in the chipset 301 with the USB version 2.0 supported by the USB device 400. Although the USB device 400 supports the USB version 2.0, the external expansion card 300 supports only the USB version 1.0. Therefore, data can only be transmitted between the external expansion card 300 and the USB device 400 at the transmission rate supported by USB version 1.0. That is, the current operating USB version and the available transmission rate thereof is USB version 1.0. The firmware will show this information via one of the three LED indicators 302 that is defined as 1.0, so as to remind a user that the current operating USB version and the available transmission rate thereof is USB 1.0.

In conclusion, when a user connecting a USB device to an electronic device, the present invention allows the user to know the USB versions supported by the currently being used USB device and the electronic device, and accordingly, the transmission rate at which the data can be transmitted between the USB device and the electronic device.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A USB version recognition device, comprising:
an indication module;
a USB connector for connecting with a USB device and receiving a first version message of the USB device;
an information source module for storing a second version message therein and being connected to the USB connector; and
a control module being connected to the indication module and the information source module, and being able to compare the first version message with the second version message to generate an operating version message and show the operating version message via the indication module.

2. The USB version recognition device as claimed in claim 1, wherein the operating version message is one of the first and the second version message that has a lower transmission rate.

3. The USB version recognition device as claimed in claim 2, wherein the first version message, the second version message and the operating version message respectively include a version number, a transmission rate or a combination thereof.

4. The USB version recognition device as claimed in claim 2, wherein the USB device includes a combination of an electronic device and at least one USB connection interface.

5. The USB version recognition device as claimed in claim 2, wherein the control module is selected from the group consisting of a Basic Input/Output System (BIOS), a driver, and a type of firmware.

6. The USB version recognition device as claimed in claim 2, wherein the indication module is selected from the group consisting of a liquid crystal display (LCD), a set of LED indicators, a speaker, and a buzzer.

7. The USB version recognition device as claimed in claim 2, wherein the USB version recognition device is applicable to any one of a computer host and an electronic device.

8. The USB version recognition device as claimed in claim 2, wherein the information source module is a chipset.

9. The USB version recognition device as claimed in claim 1, wherein the first version message is a USB version 3.0 standard, the second version message is a USB version 2.0.

10. The USB version recognition device as claimed in claim 9, wherein the first version message, the second version message and the operating version message respectively include a version number, a transmission rate or a combination thereof.

11. The USB version recognition device as claimed in claim 9, wherein the USB device includes a combination of an electronic device and at least one USB connection interface.

12. The USB version recognition device as claimed in claim 9, wherein the control module is selected from the group consisting of a Basic Input/Output System (BIOS), a driver, and a type of firmware.

13. The USB version recognition device as claimed in claim 9, wherein the indication module is selected from the group consisting of a liquid crystal display (LCD), a set of LED indicators, a speaker, and a buzzer.

14. The USB version recognition device as claimed in claim 9, wherein the USB version recognition device is applicable to any one of a computer host and an electronic device.

15. The USB version recognition device as claimed in claim 9, wherein the information source module is a chipset.
